(19) United States
(12) Patent Application Publication
(10) Pub. No.: US 2025/0189379 A1
(43) Pub. Date: Jun. 12, 2025

(54) BODY TEMPERATURE ESTIMATION DEVICE, BODY TEMPERATURE ESTIMATION METHOD, AND RECORDING MEDIUM

(71) Applicant: Panasonic Intellectual Property Management Co., Ltd., Osaka (JP)

(72) Inventors: Shinichi SHIKII, Nara (JP); Aki YONEDA, Hyogo (JP); Kenichiro NOSAKA, Osaka (JP); Mototaka YOSHIOKA, Osaka (JP)

(73) Assignee: Panasonic Intellectual Property Management Co., Ltd., Osaka (JP)

(21) Appl. No.: 18/844,792

(22) PCT Filed: Dec. 13, 2022
(86) PCT No.: PCT/JP2022/045770

§ 371 Date: Sep. 6, 2024

(30) Foreign Application Priority Data
Mar. 23, 2022 (JP) 2022-046693

(51) Int. Cl. G01J 5/48; G06T 7/00

(52) U.S. Cl. CPC G01J 5/48; G06T 7/0012; G06T 2207/10048; G06T 2207/30201

(57) ABSTRACT

A body temperature estimation device includes: a thermal image obtainer that captures a face of a user in a capturing direction to obtain a thermal image including the face and a lateral side of a head of the user, the capturing direction being a direction that obliquely intersects a reference direction in which the user faces for body temperature estimation; and an estimator that estimates a body temperature of the user based on the thermal image.

### TECHNICAL FIELD

The present disclosure relates to a body temperature estimation device, a body temperature estimation method, and a program.

### BACKGROUND ART

Patent Literature (PTL) 1 discloses a technique for estimating a core body temperature of a person using a thermal image.

### CITATION LIST

### Patent Literature

[PTL 1] Japanese Unexamined Patent Application Publication No. 2018-183564

### SUMMARY OF INVENTION

### Technical Problem

More accurate estimation of a body temperature of a user has been demanded.

Therefore, the present disclosure provides a body temperature estimation device and so on that can estimate a body temperature of a user more accurately.

### Solution to Problem

A body temperature estimation device according to one aspect of the present disclosure includes: a thermal image obtainer that captures a face of a user in a capturing direction to obtain a thermal image including the face and a lateral side of a head of the user, the capturing direction being a direction that obliquely intersects a reference direction in which the user faces for body temperature estimation; and an estimator that estimates a body temperature of the user based on the thermal image.

Moreover, a body temperature estimation method according to one aspect of the present disclosure includes: capturing a face of a user in a capturing direction to obtain a thermal image including the face and a lateral side of a head of the user, the capturing direction being a direction that obliquely intersects a reference direction in which the user faces for body temperature estimation; and estimating a body temperature of the user based on the thermal image.

Note that these general or specific aspects may be implemented as a system, a method, an integrated circuit, a computer program, or a non-transitory recording medium such as a computer readable CD-ROM, or may be implemented as any combination of systems, methods, integrated circuits, computer programs, and non-transitory recording media.

### Advantageous Effects of Invention

The body temperature estimation device and so on according to the present disclosure can estimate a body temperature of a user more accurately.

### BRIEF DESCRIPTION OF DRAWINGS

FIG. 1 is a diagram illustrating an example of an appearance of a body temperature estimation device according to an embodiment.

FIG. 2 is a diagram illustrating an example of a hardware configuration of the body temperature estimation device according to the embodiment.

FIG. 3 is a diagram illustrating an example of a plan view of the body temperature estimation device according to the embodiment as viewed from the front.

FIG. 4 is a diagram for illustrating a positional relationship between (i) a thermal imaging camera and a camera and (ii) a user.

FIG. 5 is a diagram illustrating an example of a functional configuration of the body temperature estimation device according to the embodiment.

FIG. 6 is a diagram for illustrating a helix and a tragus.

FIG. 7 is a diagram illustrating an example of a thermal image of the face of a user captured from an angle.

FIG. 8 is a flowchart illustrating an example of operations of the body temperature estimation device according to the embodiment.

FIG. 9 is a diagram illustrating an example of a plan view of a body temperature estimation device according to (1) of a variation as viewed from the front.

FIG. 10 is a diagram illustrating an example of a plan view of a body temperature estimation device according to (3) of the variation as viewed from the front.

FIG. 11 is a diagram illustrating another example of a plan view of the body temperature estimation device according to (3) of the variation as viewed from the front.

FIG. 12 is a diagram illustrating an example of a plan view of a body temperature estimation device according to (4) of the variation as viewed from the front.

FIG. 13 is a diagram illustrating an example of a plan view of a body temperature estimation device according to (5) of the variation as viewed from the above.

### DESCRIPTION OF EMBODIMENTS

### (Underlying Knowledge Forming Basis of the Present Disclosure)

The inventors found that the following problems arise with the conventional technique for estimating a body temperature of a person.

When a body temperature of a user is estimated using a thermal image, a technique of using a thermal image obtained by a thermal imaging camera directly facing the user to estimate a body temperature of the user has been known. Such a technique estimates the body temperature of the user, for example, based on the temperature of the forehead of the user.

However, the temperature distributions of the face of the user are approximately the same on the left and right sides and approximately symmetrical, and therefore half the information is redundant information. In other words, the inventors found that if a thermal image of the face of a user that includes different temperature distributions on the left and right sides of the thermal image can be obtained, this may lead to accurate estimation of a body temperature of a user.

Therefore, the inventors have conceived a body temperature estimation device that can estimate a body temperature of a user accurately.

A body temperature estimation device according to one aspect of the present disclosure includes: a thermal image obtainer that captures a face of a user in a capturing direction to obtain a thermal image including the face and a lateral side of a head of the user, the capturing direction being a direction that obliquely intersects a reference direction in which the user faces for body temperature estimation; and an estimator that estimates a body temperature of the user based on the thermal image.

With this, the face of the user is captured in a direction that obliquely intersects the reference direction in which the user faces for body temperature estimation, and thus an asymmetric thermal image including the face of the user can be obtained. Therefore, a thermal image including more information than a thermal image captured from the front can be obtained, and the body temperature of the user can be accurately estimated.

A body temperature estimation device according to a second aspect of the present disclosure is the body temperature estimation device according to the first aspect, and the lateral side of the head included in the thermal image includes an ear of the user.

Since the thermal image is a result of detecting the temperature of the body surface of the user, it is susceptible to the temperature around the user, such as outside air. Since the thermal image includes an ear that is susceptible to the temperature around the user, it is possible to estimate the body temperature of the user according to the influence of the temperature around the user.

Therefore, the body temperature of the user can be estimated robustly against the temperature around the user.

A body temperature estimation device according to a third aspect of the present disclosure is the body temperature estimation device according to the second aspect, and the ear of the user included in the thermal image includes a tragus and a helix.

Therefore, it is possible to estimate the body temperature of the user robustly against the temperature around the user.

A body temperature estimation device according to a fourth aspect of the present disclosure is the body temperature estimation device according to the third aspect, and further includes a display unit that displays an image. The thermal image obtainer is disposed at a position other than at a center in a horizontal direction of a display surface of the display unit, and the reference direction is a direction in which the user directly faces the display unit.

Therefore, when capturing the thermal image in a state in which the user is seeing an image on the display unit while the user is directly facing the display unit, the thermal image obtainer can capture the face of the user in a capturing direction that obliquely intersects the reference direction in which the user is directly facing. Therefore, a thermal image including the face and the lateral side of the head of the user can be easily obtained.

A body temperature estimation device according to a fifth aspect of the present disclosure is the body temperature estimation device according to the fourth aspect, and further includes an image obtainer that captures the user directly facing the display unit to obtain a face image of the user. The display unit displays the face image, and the thermal image obtainer is disposed at a position other than a position of the image obtainer in the horizontal direction.

Therefore, when capturing the thermal image in a state in which the user is seeing a face image of the user on the display unit while the user is directly facing the display unit, the thermal image obtainer can capture the face of the user in a capturing direction that obliquely intersects the reference direction in which the user directly faces. Therefore, a thermal image including the face and the lateral side of the head of the user can be easily obtained.

A body temperature estimation device according to a sixth aspect of the present disclosure is the body temperature estimation device according to any one of the first to third aspects, and the thermal image obtainer is disposed in a portion of a mirror or on an edge of a reflective surface of the mirror, and the reference direction is a direction in which the user directly faces the mirror.

Therefore, when capturing the thermal image in a state in which the user is seeing the face of the user in the mirror while the user is directly facing the mirror, the thermal image obtainer can capture the face of the user in a capturing direction that obliquely intersects the reference direction in which the user directly faces. Therefore, a thermal image including the face and the lateral side of the head of the user can be easily obtained.

A body temperature estimation device according to a seventh aspect of the present disclosure is the body temperature estimation device according to any one of the first to sixth aspects, and the capturing direction of the thermal image obtainer intersects the reference direction at an angle of at least 10 degrees.

This makes it possible to capture a thermal image that includes more of the lateral side of the head of the user.

A body temperature estimation device according to an eighth aspect of the present disclosure is the body temperature estimation device according to the seventh aspect, and the capturing direction of the thermal image obtainer intersects the reference direction at an angle of at most 90 degrees.

This makes it possible to capture a thermal image that includes more of the face of the user.

A body temperature estimation device according to a ninth aspect of the present disclosure is the body temperature estimation device according to any one of the first to eighth aspects, and the estimator estimates the body temperature of the user when the thermal image includes an ear of the user, and does not estimate the body temperature of the user when the thermal image does not include the ear of the user.

With this, when the estimation accuracy is low, the body temperature of the user is not estimated. Therefore, the processing load on the estimation process can be reduced.

A body temperature estimation device according to a tenth aspect of the present disclosure is the body temperature estimation device according to the ninth aspect, and further includes a notifier that outputs a notification prompting the user to turn the face in the reference direction when the thermal image does not include the ear of the user.

This makes it possible to cause the user to change the orientation of the face to improve the estimation accuracy. Therefore, it is possible to obtain a result of body temperature estimation with high estimation accuracy.

A body temperature estimation device according to an eleventh aspect of the present disclosure is the body temperature estimation device according to any one of the first to tenth aspects, and further includes an outputter that outputs the body temperature of the user estimated by the estimator.

Therefore, it is possible to utilize the estimated body temperature of the user.

A body temperature estimation device according to a twelfth aspect of the present disclosure is the body temperature estimation device according to the eleventh aspect, and the outputter outputs the body temperature of the user when the thermal image includes an ear of the user, and does not output the body temperature of the user when the thermal image does not include the ear of the user.

With this, when the estimation accuracy is low, the body temperature of the user is not output. Therefore, it is possible to inhibit utilization of the estimation result with low accuracy.

A body temperature estimation method according to a thirteenth aspect of the present disclosure includes: capturing a face of a user in a capturing direction to obtain a thermal image including the face and a lateral side of a head of the user, the capturing direction being a direction that obliquely intersects a reference direction in which the user faces for body temperature estimation; and estimating a body temperature of the user based on the thermal image.

With this, the face of the user is captured in a capturing direction that obliquely intersects the reference direction in which the user is facing for body temperature estimation, and thus an asymmetric thermal image including the face of the user can be obtained. Therefore, a thermal image including more information than a thermal image captured from the front can be obtained, and the body temperature of the user can be accurately estimated.

A program according to a fourteenth aspect of the present disclosure is a program for causing a computer to execute the body temperature estimation method according to the thirteenth aspect.

Note that these general or specific aspects may be implemented as a system, a method, an integrated circuit, a computer program, or a non-transitory recording medium such as a computer readable CD-ROM, or may be implemented as any combination of systems, methods, integrated circuits, computer programs, and non-transitory recording media.

The following describes an embodiment in detail with reference to the drawings. Note that each embodiment described below shows a general or specific example. In other words, the numerical values, shapes, materials, structural elements, the arrangement and connection of the structural elements, etc. shown in the following embodiment are mere examples, and are not intended to limit the scope of the present disclosure. Among the structural elements in the following embodiment, structural elements not recited in any one of the independent claims representing broadest concepts are described as structural elements that are not necessarily needed to achieve the problems to be solved by the present disclosure but included in a more preferable embodiment.

### EMBODIMENT

### 1. Configuration

First, a configuration of a body temperature estimation device according to the present disclosure will be described.

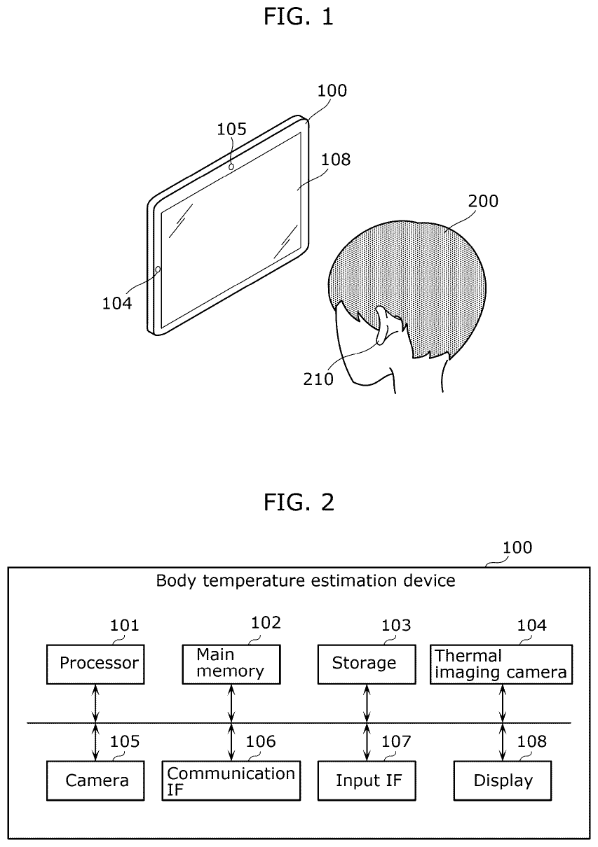

FIG. 1 is a diagram illustrating an example of an appearance of a body temperature estimation device according to an embodiment.

Body temperature estimation device 100 is a device that estimates a body temperature of user 200 based on a thermal image obtained by capturing the face of user 200 by thermal imaging camera 104. Body temperature estimation device 100 specifically estimates the body temperature of user 200 based on the thermal image of the face including ear 210 of user 200. In the present embodiment, body temperature estimation device 100 includes, for example, a tablet terminal.

FIG. 2 is a diagram illustrating an example of a hardware configuration of the body temperature estimation device according to the embodiment.

Body temperature estimation device 100 includes processor 101, main memory 102, storage 103, thermal imaging camera 104, camera 105, communication interface (IF) 106, input interface (IF) 107, and display 108.

Processor 101 is a processor that executes a program stored in storage 103, etc.

Main memory 102 is a volatile storage area used as a work area when processor 101 executes a program.

Storage 103 is a non-volatile storage area that holds various types of data such as programs.

Thermal imaging camera 104 generates a thermal image by detecting a two-dimensional temperature distribution in a capturing range. The thermal image includes a plurality of pixels aligned in the vertical direction and the horizontal direction. Each of the plurality of pixels has a pixel value indicating a temperature detected at a position corresponding to the position of the pixel in the capturing range of thermal imaging camera 104.

Camera 105 captures a still image or a video within the capturing range. Camera 105 may be an RGB camera or a monochrome camera. In other words, the image produced by camera 105 may be an RGB image in which each of pixels including sub-pixels of red (R), green (G), and blue (B) arranged in the vertical and horizontal directions in the image produced by camera 105, or may be a monochrome image including pixels of white only.

Communication IF 106 is a communication interface for data transmission to and from external devices such as smartphones, tablets, personal computers (PCs), and servers. Communication IF 106 may be an interface for wireless communication, for example, a wireless LAN interface and a Bluetooth (registered trademark) interface. Communication IF 106 may be an interface for wired communication, such as Universal Serial Bus (USB) and a wired LAN interface. Note that, communication IF 106 is not limited to the above examples, and may be a communication interface for transmitting data to and from external devices via a communication network.

Input IF 107 is an interface for receiving input by a person. Input IF 107 may be a pointing device such as a touch panel. The pointing device is not limited to a touch panel, but may also be a mouse, a touchpad, a trackball, etc. In addition, input IF 107 is not limited to a pointing device, and may be a keyboard.

Display 108 is, for example, a liquid crystal display, organic EL display, etc.

Note that body temperature estimation device 100 does not need to include at least one of camera 105, communication IF 106, input IF 107 or display 108.

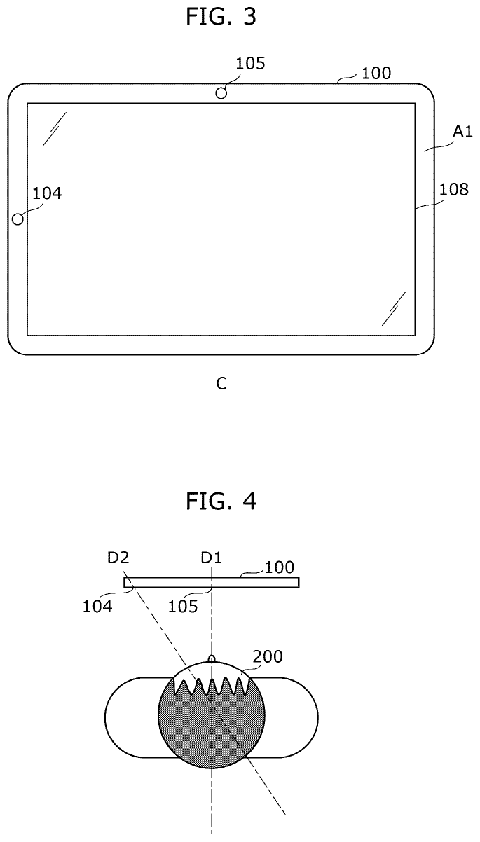

FIG. 3 is a diagram illustrating an example of a plan view of the body temperature estimation device according to the embodiment as viewed from the front. Here, the positions of thermal imaging camera 104 and camera 105 relative to body temperature estimation device 100 will be described.

As illustrated in the figure, body temperature estimation device 100 is a tablet terminal having a rectangular plate shape. Body temperature estimation device 100 includes display 108, thermal imaging camera 104, and camera 105 that are disposed on the front side. As viewed from the front, display 108 does not extend to the periphery of body temperature estimation device 100. In other words, between the periphery of body temperature estimation device 100 and display 108 as viewed from the front, there is non-display area A1 having an annular shape where nothing is displayed. Non-display area A1 includes an annular area, which includes four areas: an upper area, a right area, a lower area, and a left area relative to display 108. Thermal imaging camera 104 and camera 105 are disposed in non-display area A1. Specifically, when body temperature estimation device 100 is placed in a predetermined orientation relative to user 200, thermal imaging camera 104 is disposed in the left area of non-display area A1 having the annular shape. In addition, when body temperature estimation device 100 is placed in the predetermined orientation relative to user 200, camera 105 is disposed at a position of the center in the horizontal direction of the upper area of non-display area A1 having the annular shape. In other words, camera 105 is disposed at the position of center C, which is the center in the horizontal direction of body temperature estimation device 100.

Here, the predetermined orientation is, for example, an orientation in which the longitudinal direction of body temperature estimation device 100 is in the horizontal direction of the face of user 200, and camera 105 is positioned above display 108. Note that the predetermined orientation may be an orientation in which camera 105 is positioned below display 108.

As described above, thermal imaging camera 104 is disposed on the left area of non-display area A1, and camera 105 is disposed at the position of center C in the horizontal direction of body temperature estimation device 100. In other words, thermal imaging camera 104 is disposed at a position other than a position of camera 105 in the horizontal direction of body temperature estimation device 100. Moreover, camera 104 is disposed at a position other than a position at the center in the horizontal direction of display 108.

Next, a positional relationship between (i) thermal imaging camera 104 and camera 105 and (ii) user 200 when user 200 directly faces the front of body temperature estimation device 100 will be described.

FIG. 4 is a diagram for illustrating a positional relationship between (i) the thermal imaging camera and the camera and (ii) a user. FIG. 4 is a plan view of body temperature estimation device 100 and user 200 as viewed from above when user 200 is directly facing the front of body temperature estimation device 100.

As illustrated in the same figure, if user 200 directly faces the front of display 108 of body temperature estimation device 100, the face of user 200 is at a position directly facing camera 105. At this time, reference direction D1 in which user 200 faces is the direction in which user 200 directly faces display 108, and therefore reference direction D1 passes through the position of camera 105. In other words, camera 105 can capture the face of user 200 from the front.

In contrast, thermal imaging camera 104 is disposed at a position on the left end of body temperature estimation device 100, which is on the left of camera 105 in the horizontal direction. Therefore, thermal imaging camera 104 captures the face of user 200 in capturing direction D2, which obliquely intersects reference direction D1.

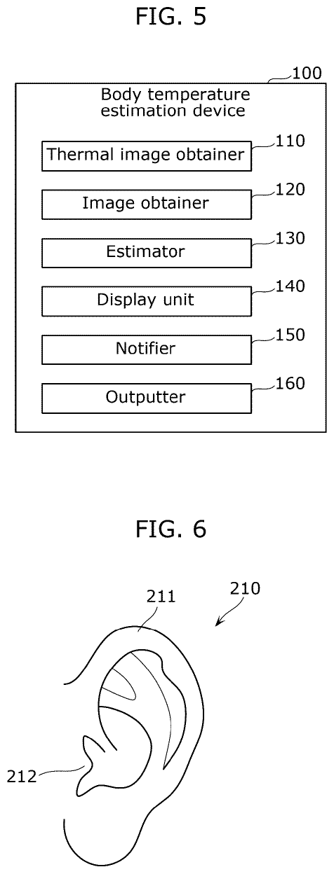

FIG. 5 is a diagram illustrating an example of a functional configuration of the body temperature estimation device according to the embodiment.

Body temperature estimation device 100 includes thermal image obtainer 110, image obtainer 120, estimator 130, display unit 140, notifier 150, and outputter 160.

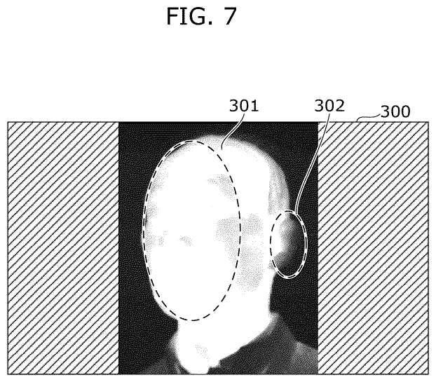

By capturing the face of user 200 in the positional relationship illustrated in FIG. 4, thermal image obtainer 110 captures the face of the user in capturing direction D2 that obliquely intersects reference direction D1 in which user 200 faces for body temperature estimation. With this, thermal image obtainer 110 obtains a thermal image including the face and the lateral side of the head of user 200. The lateral side of the head of user 200 includes ear 210 of user 200. In addition, ear 210 includes tragus 212 and helix 211, as illustrated in FIG. 6. Thermal image obtainer 110 is implemented by, for example, thermal imaging camera 104.

By capturing the face of user 200 in the positional relationship illustrated in FIG. 4, image obtainer 120 captures the frontal face of user 200 directly facing display 108. With this, thermal image obtainer 120 obtains a face image, which is a front image of the face of user 200. In other words, image obtainer 120 obtains an image of the user captured from a horizontally different position from the position where the thermal image has been captured. Image obtainer 120 is implemented by, for example, camera 105.

Estimator 130 estimates a body temperature of user 200 based on the thermal image obtained by thermal image obtainer 110. Specifically, estimator 130 may estimate a body temperature of user 200 from the obtained thermal image using a machine learning model. For example, a machine learning model may be generated using a training dataset containing multiple combinations of (i) thermal images including the face and the lateral side of the head and of user 200 (ii) correct data which includes results of body temperatures measured by a thermometer at the armpit or under the tongue of user 200 when the respective thermal images have been captured.

Note that, estimator 130 is not limited to estimating the body temperature of user 200 using a machine learning model, but is also used to estimate the body temperature of user 200 based on the temperature at a part in the frontal face (for example, forehead) of user 200 and the lateral side of the head of user 200 (for example, ear) in a thermal image. Estimator 130 may estimate the body temperature of user 200 by correcting the temperature of the forehead according to the temperature of the ear. Estimator 130 may correct the temperature of the forehead such that the body temperature that can be estimated from the temperature of the forehead is higher as the temperature of the ear is lower.

Moreover, estimator 130 may determine whether a thermal image includes ear 210 of user 200. When the thermal image includes ear 210 of user 200, estimator 130 may estimate body temperature of user 200. When the thermal image does not include ear 210 of user 200, estimator 130 does not need to estimate a body temperature of user 200.

Estimator 130 is implemented by, for example, processor 101, main memory 102, and storage 103.

Display unit 140 displays an image. Specifically, display unit 140 may display a face image captured by image obtainer 120. In other words, by displaying an image of the frontal face of user 200, display unit 140 can effectively prompt user 200 to directly face display unit 140. This enables thermal image obtainer 110 to capture the face of user 200 in capturing direction D2, which obliquely intersects reference direction D1. Display unit 140 is implemented by, for example, display 108.

FIG. 7 is a diagram illustrating an example of a thermal image of the face of a user captured from an angle.

Thermal image 300 indicates that the temperature is higher as the color is closer to white, and the temperature is lower as the color is closer to black. Note that the hatched areas in thermal image 300 correspond to the background areas. In practice, a background may be included in the hatched areas. In other words, illustration of background areas is omitted in FIG. 7. Thermal image 300 includes area 301 including the frontal face of user 200 and area 302 including ear 210 in the lateral side of the head of user 200. It can be seen that area 301 includes many pixels close to white. On the other hand, the pixels in area 302 are closer to black than the pixels in area 301. Accordingly, thermal image 300 including area 301 including the frontal face of user 200 and area 302 including ear 210 of the lateral side of the head of user 200 includes more information than the thermal image in which a frontal face is captured and which includes similar temperature distributions on the left and right sides of the face.

In order for estimator 130 to accurately estimate the body temperature of user 200, it is necessary to obtain a thermal image that includes not only the frontal face but also the lateral side of the head of user 200. The temperature of the lateral side of the head of user 200 is lower than the temperature in the area including the frontal face of user 200. This indicates that the surface temperature of the lateral side of the head is susceptible to the outside temperature, and by using the temperature of the lateral side of the head, it is possible to estimate the body temperature accurately based on the influence of the outside temperature. In other words, it is possible to accurately estimate a body temperature even under conditions where the outside temperature is different. In particular, inclusion of ear 210 in the lateral side of the head enables highly accurate body temperature estimation based on the influence of external temperature. For example, capturing direction D2 of thermal image obtainer 110 may preferably intersect reference direction D1 at an angle of at least 10 degrees. With this, thermal image obtainer 110 can obtain a thermal image that includes more of the lateral side of the head of user 200. On the other hand, the thermal image is necessary to include the face of user 200. Therefore, for example, capturing direction D2 of thermal image obtainer 110 may preferably intersect reference direction D1 at an angle of at most 90 degrees. With this, thermal image obtainer 110 can obtain a thermal image that includes more of the face of user 200. In particular, the thermal image preferably includes ear 210 of user 200, and further include helix 211 and tragus 212 of ear 210 of user 200 such that helix 211 and tragus 212 of user 200 can be distinguished from each other. In other words, by adjusting the positional relationship between body temperature estimation device 100 and the face of user 200 so that capturing direction D2 of thermal image obtainer 110 intersects reference direction D1 at an angle of at least 10 degrees and at most 90 degrees, thermal image obtainer 110 can obtain a thermal image that includes both the face and the lateral side of the head of user 200 in a well-balanced manner. Therefore, estimator 130 can estimate the body temperature of user 200 more accurately.

When estimator 130 estimates that the thermal image does not include ear 210 of user 200, notifier 150 outputs a notification prompting user 200 to turn the face in reference direction D1, that is, a direction in which user 200 directly faces display 108 of body temperature estimation device 100. Notifier 150 may display, on display unit 140, a message prompting user 200 to turn the face to reference direction D1, output the message by sound from a loudspeaker (not illustrated) included in body temperature estimation device 100, or transmit information to a terminal (not illustrated) carried by user 200 to output the message to user 200. In addition, notifier 150 may transmit information for outputting the message to the display unit or the loudspeaker provided in a space where body temperature estimation device 100 is disposed to output the message to user 200. Notifier 150 is implemented by, for example, processor 101, main memory 102, storage 103, communication IF 106, and display 108.

Outputter 160 outputs the body temperature of user 200 estimated by estimator 130. Outputter 160 may output the body temperature of user 200 when estimator 130 determines that the thermal image includes ear 210 of user 200, and does not need to output the body temperature of user 200 when estimator 130 determines that the thermal image does not include ear 210 of user 200.

Outputter 160 may output the body temperature of user 200 by causing display unit 140 to display the estimated body temperature of user 200. Outputter 160 may output the body temperature of user 200 by causing a loudspeaker (not illustrated) included in body temperature estimation device 100 to output the estimated body temperature of user 200 by sound. Outputter 160 may output the body temperature of user 200 by transmitting information showing the body temperature of user 200 to a terminal (not illustrated) carried by user 200. Outputter 160 may output the body temperature of user 200 by transmitting information indicating the body temperature of user 200 to an external device such as a server (not illustrated). Outputter 160 is implemented by, for example, processor 101, main memory 102, storage 103, communication IF 106, and display 108.

Note that the body temperature of user 200 estimated by estimator 130 may be accumulated in storage 103 of body temperature estimation device 100. In this case, body temperature estimation device 100 may identify a user by performing facial recognition on the image obtained by image obtainer 120 and accumulate the estimated body temperature of each identified user. In other words, the estimated body temperature may be managed by associating the estimated body temperature with identification information of each user. Moreover, the estimated body temperature associated with the time at which the body temperature has been estimated may be recorded.

### 2. Operation

Next, operations of body temperature estimation device 100 will be described.

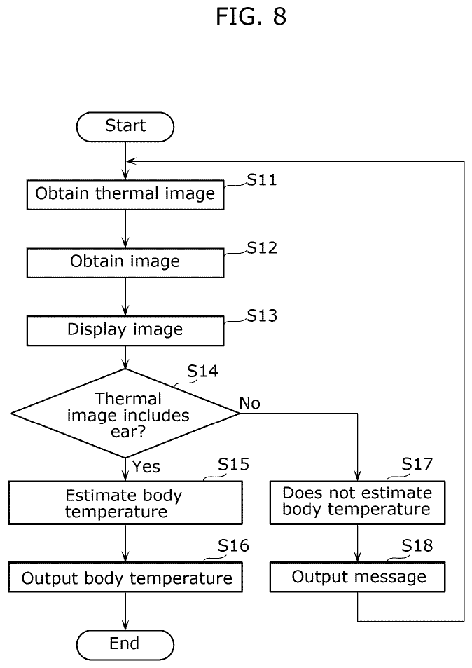

FIG. 8 is a flowchart illustrating an example of operations of the body temperature estimation device according to the embodiment.

Body temperature estimation device 100 captures the face of user 200 in capturing direction D2 to obtain a thermal image including the face and a lateral side of the head of user 200 (S11). Capturing direction D2 is a direction that obliquely intersects reference direction D1 in which user 200 faces for body temperature estimation.

Next, body temperature estimation device 100 captures user 200 directly facing display 108 to obtain a face image of user 200 (S12). Note that step S12 does not need to be performed after step S11, and may be performed in parallel with step S11.

Next, body temperature estimation device 100 displays the face image (S13).

Next, body temperature estimation device 100 determines whether an ear is included in the thermal image obtained in step S11 (S14).

When body temperature estimation device 100 determines that an ear is included in the thermal image (Yes in S14), body temperature estimation device 100 estimates the body temperature of user 200 using the thermal image (S15).

Then, body temperature estimation device 100 outputs the estimated body temperature of user 200 (S16).

On the other hand, when body temperature estimation device 100 determines that an ear is not included in the thermal image (No in S14), body temperature estimation device 100 does not estimate the body temperature of the user using the thermal image (S17).

Then, body temperature estimation device 100 outputs a message prompting user 200 to turn the face in a direction that directly faces display 108 of body temperature estimation device 100 (S18).

When step S18 ends, the processing returns to step S11. Note that, when the result of the determination is No in step S14, step S18 may be performed before step S17 or in parallel with step S17.

Moreover, when step S16 ends, the processing may return to step S11 without ending the process.

Note that, in step S14, body temperature estimation device 100 may determine whether the face of user 200 is in a predetermined direction. The predetermined direction is a direction that obliquely intersects capturing direction D2, and is included in the angle range of at least 10 degrees and at most 90 degrees relative to capturing direction D2. In other words, reference direction D1 is an example of the predetermined direction. In the determination, if Yes, step S15 is performed; and if No, step S17 is performed.

Moreover, in step S14, instead of determining whether an ear is included in the thermal image, it is possible to determine whether only one of the cheeks of user 200 is captured, or whether only one eye is captured. Here, if it is confirmed that the face of user 200 is captured in an oblique direction, other methods may be used.

### 3. Effects, Etc.

Body temperature estimation device 100 according to the present embodiment includes thermal image obtainer 110 and estimator 130. Thermal image obtainer 110 captures the face of user 200 in capturing direction D2 to obtain a thermal image including the face and a lateral side of the head of user 200. Capturing direction D2 is a direction that obliquely intersects reference direction D1 in which user faces for body temperature estimation. Estimator 130 estimates a body temperature of the user based on the thermal image.

With this, the face of user 200 is captured in capturing direction D2 that obliquely intersects reference direction D1 in which user 200 faces for body temperature estimation, and thus an asymmetric thermal image including the face of user 200 can be obtained. Therefore, a thermal image including more information than a thermal image captured from the front can be obtained, and the body temperature of user 200 can be accurately estimated.

Moreover, in body temperature estimation device 100 according to the present embodiment, the lateral side of the head included in the thermal image includes ear 210 of user 200. Since the thermal image is a result of detecting the temperature of the body surface of user 200, the thermal image is susceptible to the temperature around user 200, such as outside air. Since the thermal image includes ear 210 that is susceptible to the temperature around user 200, it is possible to estimate the body temperature of user 200 according to the influence of the temperature around user 200. Therefore, the body temperature of user 200 can be estimated robustly against the temperature around user 200.

Moreover, in body temperature estimation device 100 according to the present embodiment, ear 210 of user 200 included in the thermal image includes tragus 212 and helix 211. Therefore, it is possible to estimate the body temperature of user 200 robustly against the temperature around user 200.

Moreover, body temperature estimation device 100 according to the present embodiment further includes display unit 140 that displays an image. Thermal image obtainer 110 is disposed at a position other than at a center in a horizontal direction of a display surface of display unit 140. Reference direction D1 is a direction in which user 200 directly faces display unit 140.

Therefore, when capturing the thermal image in a state in which user 200 is seeing the image on display unit 140 while user 200 is directly facing display unit 140, thermal image obtainer 110 can capture the face of user 200 in capturing direction D2 that obliquely intersects reference direction D1 in which user 200 directly faces. Therefore, a thermal image including the face and the lateral side of the head of user 200 can be easily obtained.

Moreover, body temperature estimation device 100 according to the present embodiment further includes image obtainer 120 that captures user 200 directly facing display unit 140 to obtain a face image of user 200. Display unit 140 displays the face image. Thermal image obtainer 110 is disposed at a position other than a position of image obtainer 120 in the horizontal direction.

Therefore, when capturing the thermal image in a state in which user 200 is seeing the face image on display unit 140 while user 200 directly facing display unit 140, thermal image obtainer 110 can capture the face of user 200 in capturing direction D2 that obliquely intersects reference direction D1 in which user 200 directly faces. Therefore, a thermal image including the face and the lateral side of the head of user 200 can be easily obtained.

Moreover, in body temperature estimation device 100 according to the present embodiment, estimator 130 estimates the body temperature of user 200 when the thermal image includes ear 210 of user 200. Estimator 130 does not estimate the body temperature of user 200 when the thermal image does not include ear 210 of user 200. With this, when the estimation accuracy is low, the body temperature of user 200 is not estimated. Therefore, the processing load on the estimation process can be reduced.

Moreover, body temperature estimation device 100 according to the present embodiment further includes: notifier 150 that outputs a notification prompting user 200 to turn the face in reference direction D1 when the thermal image does not include ear 210 of user 200. This makes it possible to cause user 200 to change the orientation of the face of user 200 to improve the estimation accuracy. Therefore, it is possible to obtain a result of body temperature estimation with high estimation accuracy.

Moreover, body temperature estimation device 100 according to the present embodiment further includes outputter 160 that outputs the body temperature of user 200 estimated by estimator 130. Therefore, it is possible to utilize the estimated body temperature of user 200.

Moreover, in body temperature estimation device 100 according to the present embodiment, outputter 160 outputs the body temperature of user 200 when the thermal image includes ear 210 of user 200. Outputter 160 does not output the body temperature of user 200 when the thermal image does not include ear 210 of user 200. With this, when the estimation accuracy is low, the body temperature of user 200 is not output. Therefore, it is possible to inhibit utilization of the estimation result with low accuracy.

### [4. Variation]

(1)

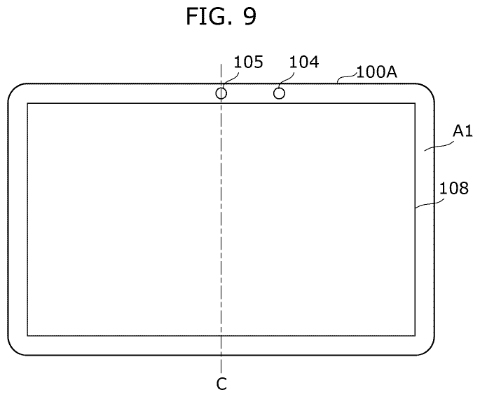

Body temperature estimation device 100A according to (1) of a variation will be described. FIG. 9 is a diagram illustrating an example of a plan view of a body temperature estimation device according to (1) of the variation as viewed from the front.

Body temperature estimation device 100A according to (1) of the variation is different from body temperature estimation device 100 according to the embodiment in the position of thermal imaging camera 104. In body temperature estimation device 100A according to (1) of the variation, thermal imaging camera 104 is disposed in the upper area of the non-display area like camera 105, and is disposed at a position other than a position of center C, where camera 105 is disposed. Also in this case, thermal imaging camera 104 can capture the face of user 200 from an angle and can obtain a thermal image including the face and the lateral side of the head of user 200.

(2)

Body temperature estimation device 100 according to the above-described embodiment includes both thermal imaging camera 104 and camera 105, but the present disclosure is not limited to this example. Body temperature estimation device 100 does not need to include camera 105. In this case, display unit 140 may display an image different from the image of the face of user 200. Display unit 140 can also prompt user 200 to directly face display unit 140 by displaying an image different from the image of the face of user 200. Moreover, display unit 140 may prompt user 200 to directly face display unit 140 by displaying a message prompting the user to directly face display unit 140.

(3)

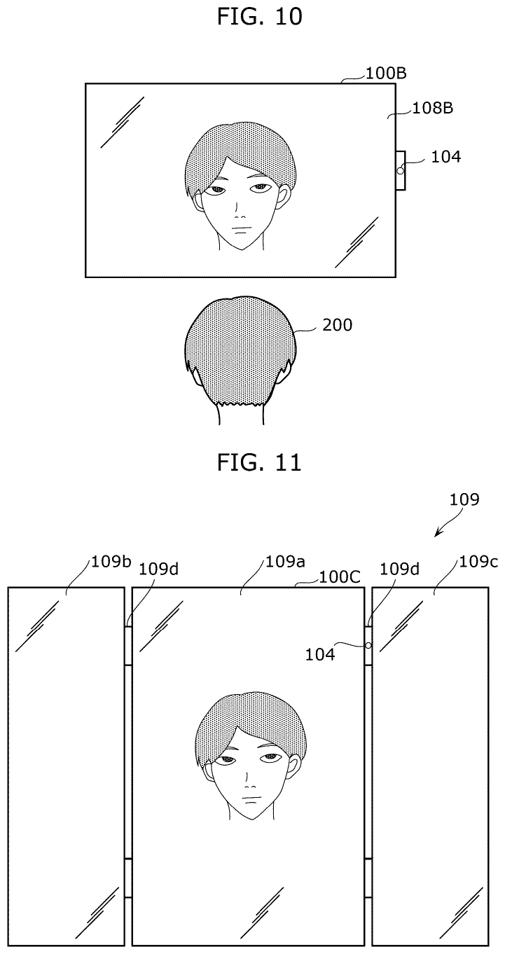

Body temperature estimation device 100B according to (3) of the variation will be described. FIG. 10 is a diagram illustrating an example of a plan view of a body temperature estimation device according to (3) of the variation as viewed from the front.

Body temperature estimation device 100B according to (3) of the variation is different from body temperature estimation device 100 according to the embodiment in that mirror 108B is included instead of display unit 140 and does not include camera 105. Thermal imaging camera 104 is disposed on an edge of a reflective surface of mirror 108B. The reference direction in this case is a direction in which user 200 directly faces the mirror.

As described above, because thermal imaging camera 104 is disposed on the edge of the reflective surface of mirror 108B, user 200 is likely to adopt an orientation to directly face mirror 108B and see the face reflected in mirror 108B. Accordingly, when thermal imaging camera 104 captures user 200 in this orientation, thermal imaging camera 104 can capture the face of the user in a capturing direction that obliquely intersects the reference direction in which user 200 directly faces. Therefore, a thermal image including the face and the lateral side of the head of user 200 can be easily obtained.

Note that body temperature estimation device 100B does not need to include mirror 108B, but may be provided on an edge of mirror 108B. In this case, body temperature estimation device 100B is sufficient to include processor 101, main memory 102, storage 103, thermal imaging camera 104, and communication IF 106.

Moreover, the body temperature estimation device according to the embodiment may also be body temperature estimation device 100C, as illustrated in FIG. 11. FIG. 11 is a diagram illustrating another example of a plan view of the body temperature estimation device according to (3) of the variation as viewed from the front.

Body temperature estimation device 100C according to (3) of the variation differs from body temperature estimation device 100B in that mirror 109 is a three-way mirror including three mirrors 109a to 109c connected by hinges 109d. In this case, thermal imaging camera 104 is disposed at one of hinges 109d. In other words, thermal imaging camera 104 is disposed on an edge of a reflective surface of mirror 109a.

Note that in body temperature estimation device 100B and body temperature estimation device 100G, thermal imaging camera 104 is disposed on the edges of the reflective surfaces of mirrors 108B and 109a, but the present disclosure is not limited to this example. Thermal imaging camera 104 may be disposed on the back side of mirror 108B and 109a to capture the face of user 200 through the glasses of mirrors 108B and 109a. In this case, thermal imaging camera 104, which is disposed on the back side of mirrors 108B and 109a, may be disposed at a position other than at the centers of mirrors 108B and 109a in the horizontal direction. In addition, when thermal imaging camera 104 is disposed on the back side of mirror 108B and 109a, it is not necessary to dispose thermal imaging camera 104 through the glass. The glass may include a penetration hole in a portion where thermal imaging camera 104 is disposed.

(4)

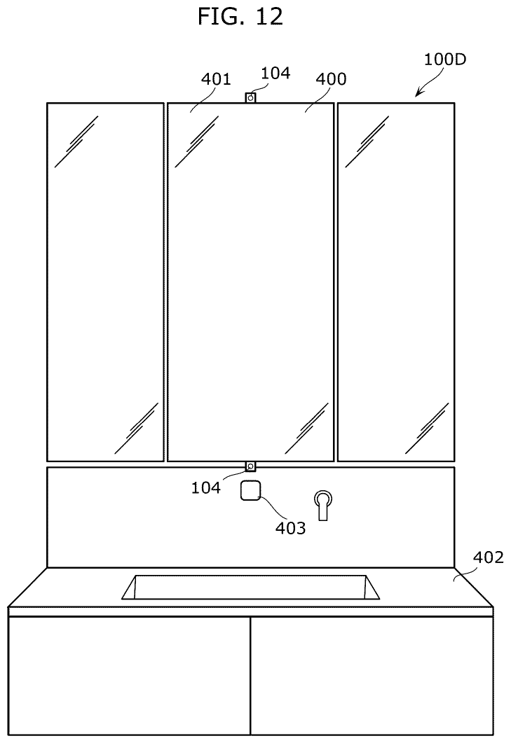

Body temperature estimation device 100D according to (4) of the variation will be described. FIG. 12 is a diagram illustrating an example of a plan view of a body temperature estimation device according to (4) of the variation as viewed from the front.

Thermal imaging camera 104 of body temperature estimation device 100D may be disposed at bathroom vanity 400. Bathroom vanity 400 includes mirror 401, sink 402, and faucet 403. Thermal imaging camera 104 may be disposed near faucet 403. Moreover, thermal imaging camera 104 may be disposed in an upper portion of mirror 401. Accordingly, by providing two thermal imaging cameras 104, a thermal image including a large area from the forehead to the neck of user 200, that is, an area including such as under the jaw, throat, the upper portion of the forehead of user 200, can be obtained. Therefore, a body temperature can be estimated highly accurately.

In addition, the timing of capturing by thermal imaging camera 104 may be set at a point in time in a period from a point in time at which water starts to be discharged from faucet 403 until a predetermined time has elapsed. When the water starts to be discharged from faucet 403, it is likely that user 200 is bringing their face close to faucet 403 to wash their face. On the other hand, if user 200 puts water on the face, it becomes difficult to obtain the body temperature of the face. Therefore, by setting the capturing timing of thermal imaging camera 104 at a point in time in a period from a point in time when water starts to be discharged from faucet 403 until a predetermined time has elapsed, it is easier to obtain a thermal image when a face without water approaches thermal imaging camera 104.

(5)

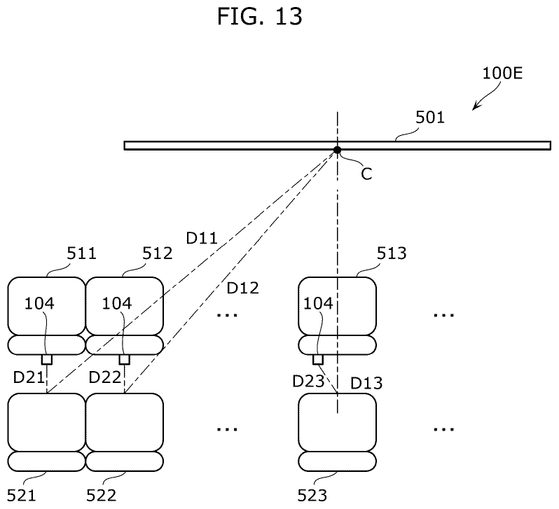

Body temperature estimation device 100E according to (5) of the variation will be described. FIG. 13 is a diagram illustrating an example of a plan view of a body temperature estimation device according to (5) of the variation as viewed from the above.

Body temperature estimation device 100E is provided in theaters such as a movie theater with screen 501. When audiences (users) in the theater are seated in seats 511 to 513, and 521 to 523, they sit facing center C of screen 501. In FIG. 13, it is illustrated that thermal imaging cameras 104 are disposed behind seats 511 to 513 in front of seats 521 to 523, in order to capture thermal images of the respective faces of the audiences seated in seats 521 to 523.

The audience seated in seat 523, which is disposed at a position of center C of screen 501, sits facing reference direction D13, which is perpendicular to screen 501. Therefore, thermal imaging camera 104 that is disposed behind seat 513 in front of seat 523 is disposed at a position other than at the center of seat 523 in a horizontal direction. As a result, thermal imaging camera 104 that is disposed behind seat 513 can capture the audience seated in seat 523 in capturing direction D23, which obliquely intersects reference direction D13, and can capture a thermal image including the face and the lateral side of the head of the audience.

Moreover, the audiences seated in seats 521 and 522, which are disposed at a position other than at center C of screen 501 in the horizontal direction, will sit facing reference directions D11 and D12, respectively, which are directions that obliquely intersect screen 501. Therefore, thermal imaging cameras 104 that are disposed behind seats 511 and 512 in front of seats 521 and 522 are respectively disposed at positions near the centers of seats 521 and 522 in the horizontal direction. This allows thermal imaging cameras 104 disposed behind seats 511 and 512 to respectively capture audiences seated in seats 511 and 512 from capturing directions D21 and D22, which obliquely intersect reference directions D11 and D12, respectively, and to capture thermal images including the faces and the lateral sides of the heads of the audiences.

Accordingly, thermal imaging camera 104 disposed on seat 511 in front of seat 521 is disposed at a position farther from the center of the rear seat than thermal imaging camera 104 disposed on seat 513 in front of seat 523, which is disposed closer to center C of screen 501 than seat 521 in the horizontal direction.

Note that, if there is something to be focused on in a predetermined area of the image displayed on screen 501 (for example, when there is something moving in center C of screen 501, or when there is an object having an illuminance greater than a specified level in center C of screen 501), each thermal imaging camera 104 may capture a thermal image and a body temperature may be estimated based on the thermal image.

Moreover, this configuration may be applied not only to movie theaters but also to other kinds of theaters and stadiums. In this case, for example, a camera may be disposed to capture a stage in a theater or a field of a stadium, and thermal imaging camera 104 may capture a thermal image when there is something moving in a predetermined range during a sports event, etc. and a body temperature may be estimated based on the thermal image.

As described above, the orientation of a face of a person may be estimated based on what the user sees, and the body temperature of the user may be estimated if a predetermined condition is satisfied. With this, a body temperature can be estimated highly accurately at an appropriate timing.

Note that, if there is a headrest in a seat, a material with low emissivity may be used for the materials of the headrest and the headrest cover because heat remaining in the headrest may cause false detection.

(6)

In the above embodiment or variation, the reference direction may be the direction directly facing display 108, the direction directly facing mirror 108B and 109a, and the direction directly facing the center of the movie theater, but the present disclosure is not limited to these examples. For example, in the case of estimating the body temperature of the user while driving an automobile, the reference direction may be the traveling direction of the automobile. In other words, if the body temperature estimation device is disposed in an automobile, thermal imaging camera 104 may be disposed at such a position that the rear view of the automobile is captured from an angle relative to the traveling direction of the automobile.

The foregoing has described the body temperature estimation device, etc. according to the embodiment of the present disclosure, but the present disclosure is not limited to this embodiment.

In addition, each processing unit included in the body temperature estimation device according to the foregoing embodiment is typically implemented as a large scale integrated (LSI) circuit, which is an integrated circuit. Each processing unit may be implemented as a single chip, and, alternatively, one or more or processing units or all of the processing units may be integrated as a single chip.

In addition, ways to achieve circuit integration are not limited to the LSI, and a dedicated circuit or a general-purpose processor may also achieve the integration. A field-programmable gate array (FPGA) that can be programmed after manufacturing LSI or a reconfigurable processor that allows re-configuration of the connection or settings of a circuit cell in LSI may be used.

In addition, the present disclosure may be implemented as a body temperature estimation device, a body temperature estimation method, etc.

Moreover, the partitioning of function blocks in the block diagrams is an example, and a plurality of functional blocks may be integrated into a single function block, a single functional block may be divided into a plurality of blocks, and part of a function may be transferred to another functional block. In addition, the functions of a plurality of functional blocks having similar functions may be processed by single hardware or software in parallel or on a time-sharing basis.

Moreover, the processing order in which the steps are executed shown in the flowcharts is a mere illustration for specifically describing the present disclosure, and thus may be an order other than the shown order. Furthermore, one or more of the steps may be executed simultaneously (in parallel) with another step.

The foregoing has described the image processing system, the image processing device, the server, the display device, etc. according to one or more aspects of the present disclosure based on the embodiment, but the present disclosure is not limited to this embodiment. Various modifications of the present embodiment as well as embodiments resulting from combinations of structural elements of the different embodiments that may be conceived by those skilled in the art may be included within the scope of the one or more aspects as long as these do not depart from the essence of the present disclosure.

### INDUSTRIAL APPLICABILITY

The present disclosure can be applied to a body temperature estimation device and a body temperature estimation method that can estimate a body temperature of a user more accurately.

### REFERENCE SIGNS LIST

100, 100A, 100B, 100C, 100D, 100E body temperature estimation device
101 processor
102 main memory
103 storage
104 thermal imaging camera
105 camera
106 communication IF
107 input IF
108 display
108B, 109, 109a to 109c mirror
109d hinge
110 thermal image obtainer
120 image obtainer
130 estimator
140 display unit
150 notifier
160 outputter
200 user
210 ear
211 helix
212 tragus
300 thermal image
301, 302 area
400 bathroom vanity
401 mirror
402 sink
403 faucet
501 screen
511 to 513, 521 to 523 seat
A1 non-display area
D1, D11 to D13 reference direction
D2, D21 to D23 capturing direction

1. A body temperature estimation device comprising:
a thermal image obtainer that captures a face of a user in a capturing direction to obtain a thermal image including the face and a lateral side of a head of the user, the capturing direction being a direction that obliquely intersects a reference direction in which the user faces for body temperature estimation; and
an estimator that estimates a body temperature of the user based on the thermal image.

2. The body temperature estimation device according to claim 1, wherein
the lateral side of the head included in the thermal image includes an ear of the user.

3. The body temperature estimation device according to claim 2, wherein
the ear of the user included in the thermal image includes a tragus and a helix.

4. The body temperature estimation device according to claim 3, further comprising:
a display unit that displays an image, wherein
the thermal image obtainer is disposed at a position other than at a center in a horizontal direction of a display surface of the display unit, and
the reference direction is a direction in which the user directly faces the display unit.

5. The body temperature estimation device according to claim 4, further comprising:
an image obtainer that captures the user directly facing the display unit to obtain a face image of the user, wherein
the display unit displays the face image, and
the thermal image obtainer is disposed at a position other than a position of the image obtainer in the horizontal direction.

6. The body temperature estimation device according to claim 1, wherein
the thermal image obtainer is disposed in a portion of a mirror or on an edge of a reflective surface of the mirror, and
the reference direction is a direction in which the user directly faces the mirror.

7. The body temperature estimation device according to claim 1, wherein
the capturing direction of the thermal image obtainer intersects the reference direction at an angle of at least 10 degrees.

8. The body temperature estimation device according to claim 7, wherein
the capturing direction of the thermal image obtainer intersects the reference direction at an angle of at most 90 degrees.

9. The body temperature estimation device according to claim 1, wherein
the estimator estimates the body temperature of the user when the thermal image includes an ear of the user, and does not estimate the body temperature of the user when the thermal image does not include the ear of the user.

10. The body temperature estimation device according to claim 9, further comprising:
a notifier that outputs a notification prompting the user to turn the face in the reference direction when the thermal image does not include the ear of the user.

11. The body temperature estimation device according to claim 1, further comprising:
an outputter that outputs the body temperature of the user estimated by the estimator.

12. The body temperature estimation device according to claim 11, wherein
the outputter outputs the body temperature of the user when the thermal image includes an ear of the user, and does not output the body temperature of the user when the thermal image does not include the ear of the user.

13. A body temperature estimation method comprising:
capturing a face of a user in a capturing direction to obtain a thermal image including the face and a lateral side of a head of the user, the capturing direction being a direction that obliquely intersects a reference direction in which the user faces for body temperature estimation; and
estimating a body temperature of the user based on the thermal image.

14. A non-transitory computer-readable recording medium having recorded thereon a program for causing a computer to execute the body temperature estimation method according to claim 13.
